(19) United States
(12) Patent Application Publication
(10) Pub. No.: US 2004/0227825 A1
(43) Pub. Date: Nov. 18, 2004

(54) Image pickup apparatus, image pickup method, program and storage medium

(75) Inventors: Takeo Sakimura, Chiba (JP); Takeshi Ogawa, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/837,663

(22) Filed: May 4, 2004

(30) Foreign Application Priority Data
May 12, 2003 (JP) 2003-133123

(51) Int. Cl. H04N 5/262

(52) U.S. Cl. 348/239

(57) ABSTRACT

When photographing is performed in a mode for photographing at least two images such as a stitch mode and an auto bracket mode, the number of photographs necessary for photographing in the mode is determined, and the number of residual photographable pictures is calculated. When the number of photographs necessary for photographing is less than the number of photographable pictures, the photographing data size is reduced or an image data recording compression ratio is increased, thereby decreasing a user's burden of ascertaining that a number of photographs necessary for photographing is less than the number of residual photographable pictures by the user himself or herself in advance in a mode for photographing at least two images.

### BACKGROUND OF THE INVENTION

1. Field of the Invention

The present invention relates to an image pickup apparatus such as a digital camera, and more particularly to an image pickup apparatus capable of performing photography in a mode for photographing at least two images.

2. Related Background Art

A digital camera for recording an image as digital data can easily perform editing, communication and the like of the image unlike a film-based camera for recoding an image on a film, and is consequently used for various purposes. A user can view then and there a photographed image, delete it or photograph the image again, without waiting the development of a film. In particular, when users commonly have an image which has photographed, it is easily possible to deliver the image to other users through transmission and receiving of files of electronic data, and therefore there is no necessity for making additional prints of the images.

Furthermore, there is a panoramic image synthesizing technique for generating an image having an equivalently high angle of view and a high precision, by photographing a plurality of images to be synthesized. The panoramic synthesizing technique includes not only a method for one-dimensional expansion in the horizontal direction or in the vertical direction, but also a method for two-dimensionally arranging n images in the vertical direction and m images in the horizontal direction. In this case, the number of photographs necessary for photographing is fixed in advance.

Now, an image pickup apparatus such as a digital camera conventionally includes a recording medium for recording photographed data. The image pickup apparatus can detect the recording capacity of the whole recording medium and the whole quantity of data recorded on the recording medium at the present time by means of an installed file system or the like. Thereby, the image pickup apparatus can calculates a residual quantity of the recording medium. The data quantity of an image changes dependently on the number of pixels of a photographed image and a compression ratio thereof corresponding to a compression file format. Furthermore, the data quantity of an image also changes dependently on the photographed image. Accordingly, a prior art digital camera sets an average photographing image data quantity according to the number of pixels of an image set at the time of photographing and a compression ratio of the image, and estimates a residual number of photographable pictures by dividing a residual capacity of a recording medium by the set data quantity to inform a user of the estimated residual number of photographable pictures. This is the same way as that the display of a number of photographable pictures of the film-based camera.

Now, it is important for the generation of a panoramic image that all of a plurality of images constituting the panoramic image is photographed. When even one of the plurality of images cannot be photographed, the generated panoramic image does not have the value as a panoramic image. For example, in case of n×m images mentioned above, the number of images necessary for the panoramic photographing is apparent, and it is necessary to photograph all of the images.

However, in case of the conventional image pickup apparatus, though the number of images necessary for photographing is apparent, a user is required to pay attention to a residual number of photographable pictures indicated by a display device incorporated in the image pickup apparatus, and the user should ensure that the number of images necessary for photographing is less than the residual number of photographable pictures. This operation is troublesome for the user. Moreover, when the user has failed to pay the attention, the residual quantity of the recording medium becomes zero during the photographing of the panoramic image, and consequently there is the problem that the user is obliged to interrupt the photographing.

### SUMMARY OF THE INVENTION

The present invention is made in view of the problem mentioned above. It is another object of the present invention to solve all of or at least one of the problems mentioned above.

It is another object of the invention to provide an image pickup apparatus capable of decreasing the troublesomeness for a user to ascertain that the number of photographs necessary for photographing is less than a remaining number of photographable pictures in a mode for photographing at least two images, and capable of securing the photographing of all of the images if possible, or of informing the user of the residual capacity being small.

In order to attain the objects, according to an aspect of the present invention, an image pickup apparatus of the present invention, which is capable of performing photography in a mode for photographing at least two images, comprises:

number-of-photograph determination means for determining a number of photographs necessary for photographing in the mode;

number-of-photographable pictures detection means for calculating a number of residual photographable pictures on the basis of a current photographing setting; and

photographing setting change means for judging whether or not the photographing setting can be changed so as to increase the number of residual photographable pictures, when the number of photographs necessary for photographing is less than the number of residual photographable pictures.

The other objects and features of the present invention will be apparent from the descriptions of the following embodiments and the attached drawings.

### BRIEF DESCRIPTION OF THE DRAWINGS

FIG. 1 is a view showing the system configuration of a digital camera of an embodiment of the present invention;

FIG. 2 is an external view of the digital camera;

FIG. 3 is a flowchart for illustrating a two-dimensional stitch mode operation;

FIG. 4 is a flowchart for illustrating an auto bracket mode operation;

FIG. 5 is an external view showing a display screen of a number-of-photographable picture determination portion in a one-dimensional stitch mode;

FIG. 6 is an external view showing a display screen in the case where photographing can be performed in a 2×2 stitch mode;

FIG. 7 is an external view showing a display screen in the case where photographing cannot be performed in the 2×2 stitch mode;

FIG. 8 is an external view showing a display screen in the case where photographing can be performed in a bracket mode; and

FIG. 9 is an external view showing a display screen in the case where photographing cannot be performed in the bracket mode.

### DETAILED DESCRIPTION OF THE PREFERRED EMBODIMENTS

In the following, the attached drawings will be referred to while the preferred embodiments of the present invention are described.

First Embodiment

In a first embodiment, which will be described in the following, a case of performing photography in a stitch mode for joining several photographed images to a panoramic image, particularly in a 2×2 stitch mode, is exemplified to be described.

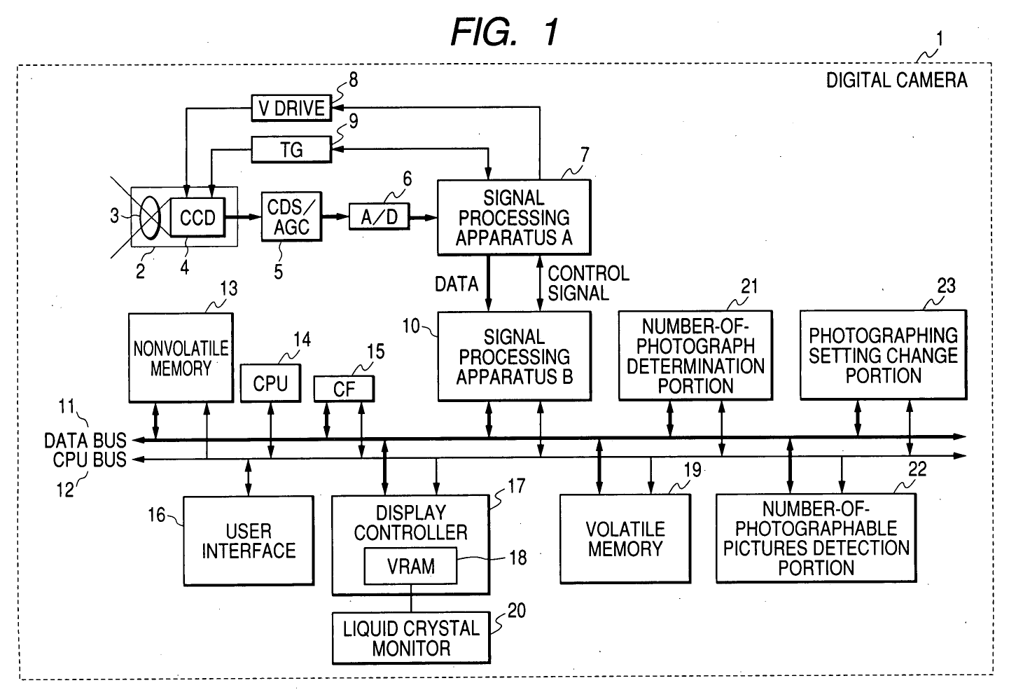

FIG. 1 shows the system configuration of a digital camera of the present embodiment. In FIG. 1, a reference numeral 1 denotes a digital camera. A reference numeral 2 denotes a photographing optical system. A reference numeral 3 denotes a lens. A reference numeral 4 denotes a charge coupled device (CCD). A reference numeral 5 denotes a correlated double sampling. (CDS)/automatic gain control (AGC) unit. A reference numeral 6 denotes an analog-to-digital (A/D) converter. A reference numeral 7 denotes a signal processing apparatus A. A reference numeral 8 denotes a V drive. A reference numeral 9 denotes a timing generator (hereinafter simply referred to as “TG”). A reference numeral 10 denotes a signal processing apparatus B.

Moreover, a reference numeral 11 denotes a data bus. A reference numeral 12 denotes a central processing unit (CPU) bus. A reference numeral 13 denotes a nonvolatile memory such as a read only memory (ROM). A reference numeral 14 denotes a CPU. A reference numeral 15 denotes a compact flash (hereinafter simply referred to as “CF”). A reference numeral 16 denotes a user interface including an operation member. A reference numeral 17 denotes a display controller. A reference numeral 18 denotes a video random access memory (VRAM). A reference numeral 19 denotes a volatile memory such as a dynamic random access memory (DRAM). A reference numeral 20 denotes a liquid crystal monitor.

Moreover, a reference numeral 21 denotes a number-of-photograph determination portion. A reference numeral 22 denotes a number-of-photographable pictures detection portion. A reference numeral 23 denotes photographing setting change portion.

First, the operation pertaining to the photographing display of the digital camera 1 will be described. All of the following control is performed by activating the software on the CPU 14 after loading it from the CF 15 or the nonvolatile memory 13 onto a program memory of the volatile memory 19. First, an image is formed on the CCD 4 with the lens 3 of the photographing optical system 2, and the formed image is photoelectrically converted to an electric signal. Then, the amplitude and the gain of the converted electric signal are adjusted by the CDS/AGC unit 5. Moreover, the electric signal is converted from an analog signal to a digital signal with the A/C converter 6. Next, the converted digital signal is further converted to the values on a color coordinate system of the image by means of the signal processing apparatus A 7. Hereupon, the color coordinate system includes various color space coordinate systems such as a Y-C coordinate system and an RCB coordinate system. However, the color coordinate system to which the present invention can be applied is not limited to a special one.

The signal processing apparatus A 7 outputs the data corresponding to the number of photographing pixels of the CCD 4 synchronously with a pixel clock. That is, in FIG. 1, the values to be output from the signal processing apparatus A 7 onto a control signal line are pixel clocks, and the values on a data line are actual image data obtained from the photographing optical system 2. Moreover, the signal processing apparatus A 7 outputs a control signal corresponding to the size of the photographing area of the CCD 4 as well as the pixel clocks on the control signal line. That is, the signal processing apparatus A 7 outputs a signal HD every start of each line of the photographing area, and a signal VD every other field of the photographing area.

In such a manner, the signal obtained through photographing by the photographing optical system 2 and color conversion performed thereafter is output synchronously with the control signal generated by the signal control apparatus A 7, and is input into the signal processing apparatus B 10. The signal processing apparatus B 10 principally controls reading and writing of data from and to the volatile memory 19, reading and writing of data from and to the CF 15, the drive of the display controller 17, writing of image displaying data of the liquid crystal monitor 20 into the VRAM 18, conversion of a signal from the CPU 14, the transmission of a control signal to the photographing optical system 2, and the transmission of image data to the outside of the digital camera 1. The image data produced by the signal processing apparatus B 10 is processed by a compression process in accordance with the joint photographic experts group (JPEG) image format, and thereby record data is generated. The generated record data is written into the CF 15 to be stored therein.

Moreover, for performing the preview at the time of photographing and for displaying an image on the liquid crystal monitor 20 at the time of reproduction, the signal processing apparatus B 10 writes the image data into the VRAM 18 through the data bus 11, and drives the display controller 17 through the CPU bus 12 at the same time. The display controller 17 displays the data in the VRAM 18 on the liquid crystal monitor 20.

In addition, the user interface 16 performs the input of user's instructions related to photographing, reproduction, mode setting, turning on and off of the liquid crystal monitor 20, and the attachment and the detachment of a card of CF 15. In the manner described above, a user can perform the photographing, the recording and the reproduction of an image.

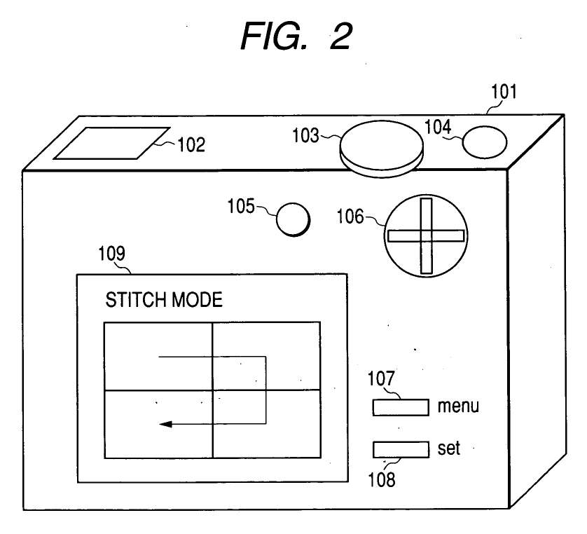

FIG. 2 shows an external view (a rear view) of the digital camera. In FIG. 2, a reference numeral 101 denotes a digital camera (corresponding to the digital camera 1 in FIG. 1). A reference numeral 102 denotes a mode display screen. A reference numeral 103 denotes a mode dial. A reference numeral 104 denotes a shutter button. A reference numeral 105 denotes an optical finder. A reference numeral 106 denotes a scroll button. A reference numeral 107 denotes a menu button. A reference numeral 108 denotes a set button. A reference numeral 109 denotes a liquid crystal display.

All of the inputs by means of the operation members shown in FIG. 2 are input into the digital camera 101 through the user interface 16 shown in FIG. 1. The mode dial 103 is used for determining the operation mode of the camera. The operation mode includes an automatic photographing mode (AUTO), a manual photographing mode, an aperture priority (Av priority) mode, a shutter priority (Tv priority) mode, a portrait mode, a sport mode, a night view mode, a stitch mode and the like as well as a reproduction mode, a mode of turning on and off of a power source, and the like.

When a user selects a stitch mode, a stitch direction selection screen is displayed on the liquid crystal display 109. The user selects any one of stitch direction among a one-dimensional horizontal direction, a one-dimensional vertical direction and a n×n two-dimensional direction. When the user selects a 2×2 stitch mode, a 2×2 screen is shown on the liquid crystal display 109, as shown in FIG. 2. In the frame on the upper left side in the screen, an image imaged by the photographing optical system 2 is displayed in real time.

The user views a photographing image on the liquid crystal display 109 or looks in the optical finder 105 while performing photographing by pushing the shutter button 104. When the recording of the image has ended, a thumbnail image of the photographed image is displayed in the frame on the upper left side, and at the same time the photographed image is displayed in the frame on the upper right side in real time. After that, similar processes are continued while four (=2×2) stitch images are photographed in accordance with the order indicated by an arrow shown in the liquid crystal display 109.

Incidentally, the order of the photographing of the stitch images is not limited to the order described above. Moreover, at the first step of the stitch photographing, the user can adjust a zoom position only once by pushing the scroll button 106 horizontally onto the right side or the left side. Moreover, the user can make the liquid crystal display 109 display a screen for performing photographing setting such a photographing image size by depressing the menu button 107, and then the user can select setting items such as the image size and the compression ratio, and can select parameter settings of respective items. The user determines the selected setting items by depressing the set button 108.

By the operation described above, four images are photographed in the 2×2 stitch mode. Each image constituting a panoramic image has no existence value as an isolated image. An image which the user intends to obtain cannot be obtained until the four images are synthesized. However, as described above, in the prior art, the user should ascertain the residual number of photographable pictures to secure that four or more photographable pictures exist before panoramic photographing is performed.

Moreover, there is also the following case. That is, though there are only three residual photographable pictures, the user selects the 2×2 stitch mode and starts photographing. Then, the user does not notice that the residual quantity of the recording medium is zero until the point of time when the user has photographed three pictures. Such a situation forces the user to have great inconvenience and a burden. Accordingly, means for enabling a user to perform a panoramic photographing without any consciousness, or for calling the user's attention to the lack of memory is necessary.

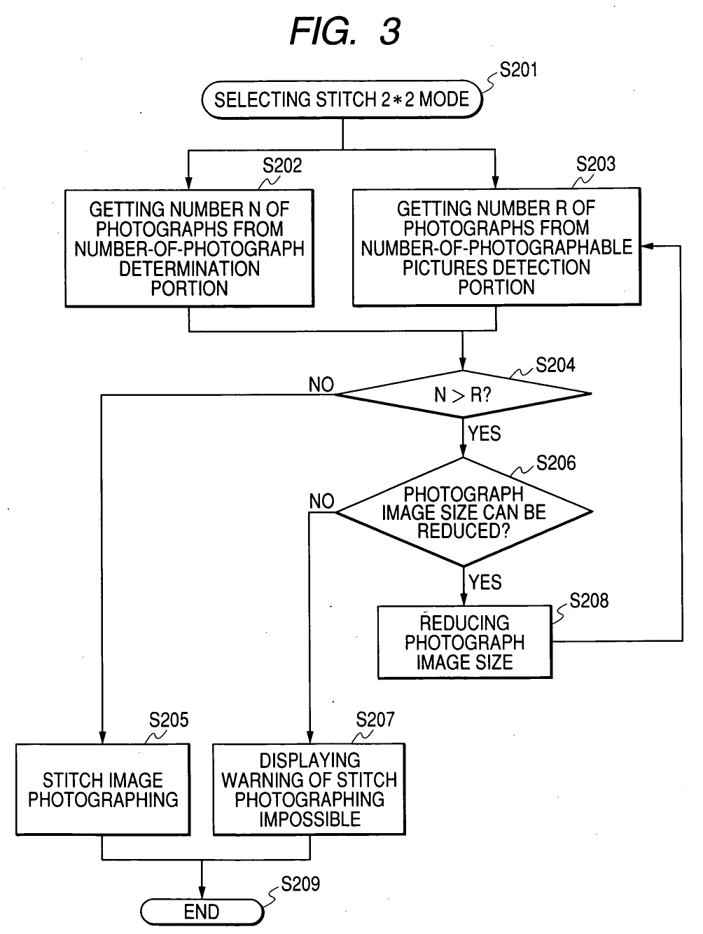

Accordingly, the present embodiment is furnished with the number-of-photograph determination portion 21, the number-of-photographable pictures detection portion 22 and the photographing setting change portion 23, as shown in FIG. 1. In the following, the operations of these portions will be described. FIG. 3 shows a flowchart for illustrating a two-dimensional stitch mode operation. First, the stitch mode is selected with the mode dial 103, and any one of the stitch directions of a one-dimensional horizontal direction, a one-dimensional vertical direction and n×m picture two-dimensional directions is selected. Then, a stitch direction selection screen is displayed on the liquid crystal display 109.

When a 2×2 stitch mode is selected (step S201), a 2×2 stitch mode screen is displayed on the liquid crystal display 109, as shown in FIG. 2. At the same time, the photographing setting change portion 23 obtains a number N of photographs necessary for photographing in the present mode from the number-of-photograph determination portion 21 (step S202), and obtains a number R of estimated residual photographable pictures from the number-of-photographable picture detection portion 22 (step S203).

At the point of time of the selection of the 2×2 stitch mode, the number-of-photograph determination portion 21 determines that the number of photographs necessary for photographing is four. Consequently, the value of N to be obtained by the photographing setting change portion 23 at the step S202 is four (N=4).

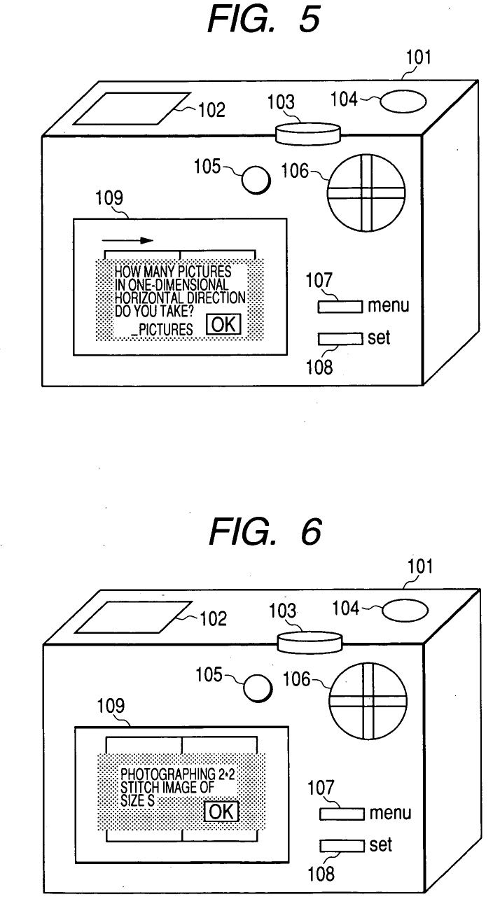

Now, the number-of-photograph determination portion 21 can automatically calculate the value of N (N=n×m) as the total number of the stitch mode of n photographs in the vertical direction by m photographs in the horizontal direction at the point of time when the photographing is started. However, the number-of-photograph determination portion 21 cannot limit the N in case of the one-dimensional stitch mode. Accordingly, in the present embodiment, a screen on which a user sets the number of photographs is displayed on the liquid crystal panel 109 as shown in FIG. 5. The user depresses the scroll button 106 into the right direction or into the left direction while increasing or decreasing the number of photographs. Then, at the time of the determination of the number of photographs, the user depresses the scroll button 106 downward to set highlight display to be “OK”. Lastly, the user depresses the “SET” button to decide the number of photographs. At this time, the number-of-photograph determination portion 21 sets the value of the N as its set value. Incidentally, the behaviour to the one-dimensional stitch mode is not limited to the process of the present embodiment.

For example, the following control method is user-friendly. That is, a process of obtaining the angle of view of the present digital camera is executed by the control of the CPU, and the number of photographs necessary for the photographing of a 360-degree panoramic image at the angle of view is calculated to calculate the value of N. Alternatively, the following specification may be adopted. That is, although the total number of photographs may be calculated in the above-mentioned case where images are obtained in the two-dimension as n×n photographs, the process of the present invention is not executed in case of the one-dimensional stitch mode in which images are obtained in the one dimension.

On the other hand, the number-of-photographable pictures detection portion 22 detects current recording space capacity of the CF 15, which is the recording medium of the images, at the time of the selection of a mode including the stitch mode by using the nonvolatile memory 13 of the digital camera 1, a file system supplied from the CF 15, or the like. Then, the number-of-photographable picture detection portion 22 holds the number of estimated residual photographable pictures obtained by dividing the detected current recording space capacity by an average image data quantity per photograph. The held number is displayed on the mode display screen 102. The value of the number R, which the photographing setting change portion 23 obtains at the step S202, corresponds to the displayed number. Now, the average image data quantity to be used in the calculation method of the number of estimated residual photographable pictures is the average image data quantity using a photographing image data size set at present and an image data recording compression ratio. However, the calculation method of the number of estimated residual photographable pictures is not limited to the method mentioned above, and any calculation methods may be adopted.

Next, the number N of photographs and the number R of estimated residual photographable pictures, which have been obtained at the steps S202 and S203, respectively, are compared (step S204). Then, when the comparison result indicates not to be N>R, namely, when the number R of residual photographable pictures is larger than the number N (=4) of photographs, which is necessary for the 2×2 stitch mode, the stitch photographing operation is continued as it is without changing the photographing image size (step S205). To the contrary, when the comparison result indicates to be N>R, namely, when there is not enough residual capacity of the recording medium for photographing all of the four (N=4) stitch constituting images, the process of the stitch mode proceeds to a step S206.

At the step S206, the photographing setting change portion 23 judges whether it is possible or not to reduce the photographing image data size. For example, it is supposed that the digital camera 1 of the present embodiment supports three kinds of image data sizes of L (1024×768), M (768×512) and S (640×480) as the image data sizes per photograph, and that the images having the M size are now selected. In this case, because the images having the S size are supported in addition to the images having the M size, it is judged that the reduction of the image sizes can be performed (step S206), and the image data size is changed to the S size (step S208).

At this time, because the number R of estimated residual photographable pictures obtained by the division of the residual capacity of the recording medium by an average value of the image data having the S size is calculated again by the number-of-photographable picture detection portion 22 (step S203), the calculated number R is further judged at the step S204. By the repetition of the operations described above, photographing is performed when the photographing of stitch images is possible in case of the reduction of the image data sizes (step S205), and a warning indicating the impossibility of stitch photographing is displayed when all of the stitch images cannot be photographed even if the image size is further reduced from the present size, for example, in the case where the residual capacity of the CF 15 is not enough to record all of the stitch images does not exist even if the image size is changed to the S size (step S207).

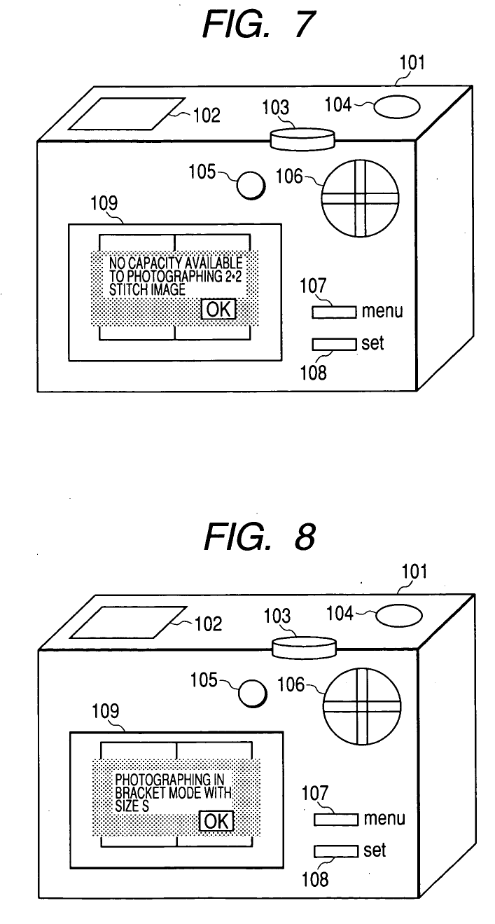

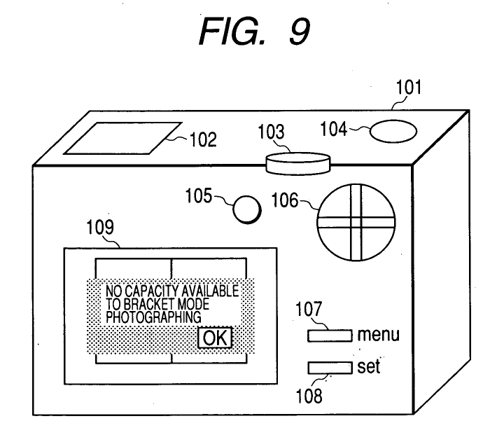

Now, the display which a user can ascertain on the liquid crystal panel 109 in the above-mentioned process will be described. When photographing in the 2×2 stitch mode is possible at the step S205, the user is informed of the setting of a specific photographing image size and the start of photographing as shown in FIG. 6. The user can ascertain whether the photographing image size is retained without change, or whether the photographing image size is reduced owing to the lack of the capacity. Moreover, at the step S207, in case that the photographing is impossible, the user is informed by display of the impossibility of the photographing of all of the 2×2 stitch mode images, though the photographing image size is minimized as shown in FIG. 7.

Thus the stitch mode can be ended (step S209).

As described above, when the record capacity for the number of photographs necessary for photographing does not remain on the recording medium in the stitch mode, the recording onto the recording medium can be performed by reducing the image data size.

Second Embodiment

In a second embodiment, which will be described in the following, a case of performing photographing in an auto bracket mode for photographing the same image a plurality of times by changing exposure among several steps is exemplified to be described. Incidentally, the configuration of the digital camera of the present embodiment is the same as that described related to the first embodiment, and accordingly the detailed description thereof is omitted.

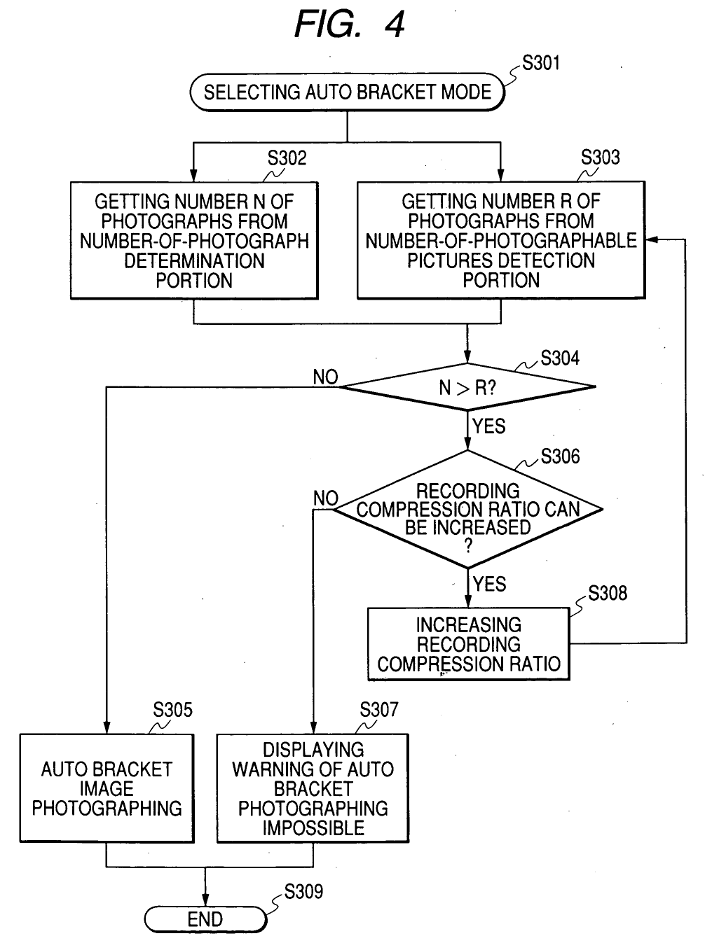

FIG. 4 shows a flowchart for illustrating the operation of the auto bracket mode. First, it is supposed that photographing setting has been selected with the menu button 107 and the auto bracket mode has been selected in the photographing setting on the liquid crystal display 109. The auto bracket mode is supposed in the present embodiment to be the mode in which exposure is changed among three steps and three to five images are obtained at once. In the following, the case where three images are photographed will be described.

Incidentally, the reason why the number of obtained images is three to five hereupon is that such the number is suitable for changing exposure condition into an increasing direction or a decreasing direction with respect to the optimum exposure condition judged by the camera.

When the auto bracket mode is selected (step S301), the photographing setting change portion 23 obtains the number N of photographs necessary for photographing in the present mode from the number-of-photograph determination portion 21 (step S302), and obtains the number R of estimated residual photographable pictures from the number-of-photographable pictures detection portion 22 (step S303).

At the point of time of the selection of the auto bracket mode, the number-of-photograph determination portion 21 determines that the number of photographs necessary for photographing is three. Consequently, the value of N to be obtained by the photographing setting change portion 23 at the step S302 is three (N=3).

On the other hand, the number-of-photographable picture detection portion 22 detects currently-available space capacity of the CF 15, which is the recording medium of the images, at the time of the selection of a mode including the auto bracket mode by using the nonvolatile memory 13 of the digital camera 1, a file system supplied from the CF 15, or the like. Then, the number-of-photographable picture detection portion 22 holds the number of estimated residual photographable pictures obtained by dividing the detected space capacity by an average image data quantity per photograph. The held number is displayed on the mode display screen 102. The value of the number R, which the photographing setting change portion 23 obtains at the step S302, corresponds to the displayed number of photographs. Now, the average image data quantity to be used in the calculation method of the number of estimated residual photographable pictures is the average image data quantity related to a photographing image data size set at present and an image data recording compression ratio. However, the calculation method of the number of estimated residual photographable pictures is not limited to the method mentioned above, and any calculation methods may be adopted.

Next, the number N of photographs and the number R of estimated residual photographable pictures, which have been obtained at the steps S302 and S303, respectively, are compared (step S304). Then, when the comparison result indicates not to be N>R, namely, when the number R of residual photographable pictures is larger than the number N (=3) of photographs, which is necessary for the auto bracket mode, the auto bracket photographing operation is continued as it is without changing the photographing image data recording compression ratio (step S305). To the contrary, when the comparison result indicates to be N>R, namely, when there is not enough residual capacity of the recording medium for photographing all of the three (N=3) auto bracket images, the process of the auto bracket mode proceeds to a step S306.

At the step S306, the photographing setting change portion 23 judges whether it is possible or not to increase the photographing image data recording compression ratio. For example, it is supposed that the digital camera 1 of the present embodiment supports three kinds of recording compression ratios of a super fine compression ratio (80%), a normal compression ratio (70%) and a rough compression ratio (60%) as the recording compression ratios for each photograph, and that the normal compression ratio system is now selected. In this case, because the rough compression ratio system is supported in addition to the normal compression ratio system, it is judged that an increase of the image data recording compression ratio can be performed (step S306), and the recording compression ratio is changed to the rough compression ratio system (step S308).

At this time, because the number R of estimated residual photographable pictures obtained by the division of the residual capacity of the recording medium by an average value of the image data of the rough compression ratio system is calculated again by the number-of-photographable pictures detection portion 22 (step S303), the calculated number R is further judged at the step S304. By the repetition of the operations described above, photographing is performed when the photographing of auto bracket images is possible even in case of the increase of the image data recording compression ratio (step S305), and a warning indicating the impossibility of auto bracket photography is displayed when all of the auto bracket images cannot be photographed even if the recording compression ratio is further increased from the present ratio, for example, in the case where the residual capacity of the CF 15 for recording all of the auto bracket images is not available even if the compression ratio system is changed to the rough compression ratio system (step S307). In the manner described above, the auto bracket mode can be ended (step S309).

Now, the display which a user can ascertain on the liquid crystal panel 109 in the above-mentioned process will be described. When photographing in the bracket mode is possible at the step S305, the user is informed of the setting of a specific photographing image size and the start of photography as shown in FIG. 6. The user can ascertain whether the photographing image size is retained without a change, or whether the photographing image size is reduced owing to the lack of the capacity. Moreover, at the step S307, when the photographing is impossible, the user is informed by display of the impossibility of the photographing of all of the bracket mode images, though the photographing image size is minimized, as shown in FIG. 7.

As described above, when the space capacity for the number of pictures necessary for photographing does not remain in the recording medium in the auto bracket mode, the record onto the recording medium can be performed by increasing the image data recording compression ratio.

Incidentally, the number of images to be obtained continuously in the auto bracket mode is not limited to the above-mentioned three (N=3). The number of images may be suitably changed by means of the setting of the image obtaining apparatus or by a manual operation of a user. However, because an odd number of photographs makes it possible to set the optimum condition at the center, it would be preferable.

Third Embodiment

In the first and the second embodiments described above, examples in which an image data size or a recording compression ratio is automatically set are described. However, a warning to a user may be performed at the point of time when it becomes apparent that the residual capacity of a recording medium is not sufficiently enough for photographing all of the stitch constituting images or the auto bracket images at the step S204 in FIG. 3 or at the step S304 in FIG. 4.

In this case, displaying a screen advising the user of the possibility of photographing all of the images, which may be caused by the reduction of image data sizes or by the increase of recording compression ratios makes, it possible to provide a more suitable photographing circumstances.

Other Embodiments

The following embodiment is also included in the aspect of the present invention. That is, in order that various devices may be operated for implementing the functions of the embodiments described above, the program codes of the software for implementing the functions of the embodiments described above are supplied to an apparatus or a computer in a system which are connected to the various devices, and the various devices are operated to implement the functions in accordance with the program stored in the computer (a CPU or a micro processing unit (MPU) of the system or the apparatus.

Moreover, in this case, the program codes of the software themselves implement the functions of the embodiments described above, and then the program codes constitute the present invention. As a transmission medium of the program codes, a communication media (wired lines such as optical fiber lines and wireless lines) in a computer network (a local area network (LAN), a wide area network (WAN) such as the Internet, a wireless communication network and the like) for supplying program information by propagating the program information as a carrier wave can be used.

Furthermore, means for supplying the program codes to a computer, such as a recording medium storing the program codes, constitutes the present invention. As the recording medium storing the program codes, for example, a flexible disk, a hard disk, an optical disk, a magneto-optical disk, a compact disk read-only memory (CD-ROM), a magnetic tape, a nonvolatile memory card, a ROM, and the like can be used.

Moreover, not only in the case where the functions of the embodiments described above are implemented by the execution of the supplied program codes by the computer, but also in the case where the functions of the embodiments described above are implemented by the cooperation of the program codes with the operating system (OS) working on the computer or the other application software and the like, it is needless to say that such program codes are included in the embodiments of the present invention.

Moreover, it is needless to say that the following case is also included in the present invention. That is, after the supplied program codes have been stored in a function enhancement board of the computer or a function enhancement unit connected to the computer, a CPU or the like which is installed on the function enhancement board or on the function enhancement unit executes a part of the actual processing, and the functions of the embodiments described above is implemented by the processing.

Incidentally, any of the shapes and structures of the respective portions shown in the embodiments described above shows only an example for embodying the present invention, and the aspect and the sprit of the present invention should not be interpreted to be limited to those shapes and structures. That is, the present invention can be implemented in various shapes without departing from the sprit or the subject matter of the present invention.

For example, in the embodiments described above, the image data sizes are reduced in the stitch mode, and the image data recording compression ratios are increased in the auto bracket mode. However, contrary cases may be adopted. Moreover, a screen enabling a user to select whether reducing the image data sizes or whether increasing the image data recording compression ratios may be displayed. Moreover, the reduction of the image data sizes and the increase of the image data recording compression ratios have been described separately. However, both of them may be performed at the same time.

The present invention is not limited to the embodiments described above, and various modifications can be done within the sphere of the following claims.

What is claimed is:

1. An image pickup apparatus capable of performing photography in a mode for photographing at least two images, said apparatus comprising:
number-of-photograph determination means for determining a number of photographs necessary for photographing in the mode;
number-of-photographable pictures detection means for calculating a number of residual photographable pictures on the basis of a current photographing setting; and
photographing setting change means for judging whether or not the photographing setting can be changed so as to increase the number of residual photographable pictures, when the number of photographs necessary for photographing is less than the number of residual photographable pictures.

2. An image pickup apparatus according to claim 1, wherein said photographing setting change means changes the photographing setting when the photographing setting can be changed so as to increase the number of residual photographable pictures.

3. An image pickup apparatus according to claim 1, wherein the photographing setting is a photographing condition pertaining to an image quality.

4. An image pickup apparatus according to claim 2, wherein the photographing setting is an image size, and said photographing setting change means reduces image sizes of at least two images to be photographed.

5. An image pickup apparatus according to claim 1, wherein the photographing setting is an image data recording compression ratio.

6. An image pickup apparatus according to claim 2, wherein the photographing setting is an image data recording compression ratio, and said photographing setting change means increases the image data recording compression ratios of at least two images to be photographed.

7. An image pickup apparatus according to claim 1, wherein said photographing setting change means warns impossibility of photographing when the photographing setting cannot be changed so as to increase the number of residual photographable pictures.

8. An image pickup apparatus according to claim 1, wherein the mode is a stitch mode for joining several photographed images to a panoramic image.

9. An image pickup apparatus according to claim 8, wherein said number-of-photograph determination means determines the number of photographs necessary for photographing as a number obtained by multiplying a number of photographs to be arranged vertically in the panoramic image and a number of photographs to be arranged horizontally in the panoramic image.

10. An image pickup apparatus according to claim 1, wherein the mode is an auto bracket mode.

11. An image pickup apparatus according to claim 10, wherein said number-of-photograph determination means determines the number of photographs necessary for photographing to be three to five in case of the auto bracket mode.

12. An image pickup apparatus capable of performing photography in a mode for photographing at least two images, said apparatus comprising:
number-of-photograph determination means for determining a number of photographs necessary for photographing in the mode;
number-of-photographable picture detection means for calculating a number of residual photographable pictures to be estimated on the basis of a current photographing setting; and
warning means for effecting a warning when the number of photographs necessary for photographing is less than the number of residual photographable pictures.

13. An imaging method using an image pickup apparatus capable of performing photographing in a mode for photographing at least two images, said method comprising the steps of:
determining a number of photographs necessary for photographing in the mode;
calculating a number of residual photographable pictures to be estimated on the basis of a current photographing setting; and
judging whether the photographing setting can be changed or not so as to increase the number of residual photographable pictures, when the number of photographs necessary for photographing is less than the number of residual photographable pictures.

14. A method using an image pickup apparatus capable of performing photography of in a mode for photographing at least two images, said method comprising the steps of:
determining a number of photographs necessary for photographing in the mode;
calculating a number of residual photographable pictures to be estimated on the basis of a current photographing setting; and
effecting a waning when the number of photographs necessary for photographing is less than the number of photographable pictures.

15. A program for controlling an image pickup apparatus capable of performing photography in a mode for photographing at least two images, said program comprising a module for performing the processes of:
determining a number of photographs necessary for performing the photography in the mode;
calculating a number of residual photographable pictures to be estimated on the basis of a current photographing setting; and
judging whether the photographing setting can be changed or not so as to increase the number of residual photographable pictures, when the number of photographs necessary for photographing is less than the number of residual photographable pictures.

16. A program for controlling an image pickup apparatus capable of performing photography in a mode for photographing at least two images, said program comprising a module for performing the processes of:
determining a number of photographs necessary for performing the photography in the mode;
calculating a number of residual photographable pictures to be estimated on the basis of a residual capacity of a recording medium capable of recording image data and a current photographing setting; and
effecting a warning when the number of photographs necessary for photographing is less than the number of residual photographable pictures.

17. A recording medium for storing a program for controlling an image pickup apparatus capable of performing photography in a mode for photographing at least two images, said program comprising a module for performing the processes of:
determining a number of photographs necessary for performing the photography in the mode;
calculating a number of residual photographable pictures to be estimated on the basis of a current photographing setting; and
judging whether the photographing setting can be changed or not so as to increase the number of residual photographable pictures, when the number of photographs necessary for photographing is less than the number of residual photographable pictures.

18. A recording medium for storing a program for controlling an image pickup apparatus capable of performing photography in a mode for photographing at least two images, said program comprising a module for performing the processes of:
determining a number of photographs necessary for performing the photography in the mode;
calculating a number of residual photographable pictures to be estimated on the basis of a residual capacity of a recording medium capable of recording image data and a current photographing setting; and
effecting a warning when the number of photographs necessary for photographing is less than the number of residual photographable pictures.
